(19) United States
(12) Patent Application Publication
(10) Pub. No.: US 2009/0103744 A1
(43) Pub. Date: Apr. 23, 2009

(54) NOISE CANCELLATION CIRCUIT FOR ELECTRONIC DEVICE

(76) Inventors: Gunnar Klinghult, Lund (SE); Andrej Petef, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(21) Appl. No.: 11/876,829

(22) Filed: Oct. 23, 2007

(51) Int. Cl. G10K 11/16

(52) U.S. Cl. 381/71.1

(57) ABSTRACT

A noise cancellation circuit for an electronic device includes a first input configured to receive an audio signal from a microphone included in the electronic device, and a second input configured to receive an accelerometer output signal from an accelerometer included in the electronic device. In addition, the noise cancellation circuit includes a comparison circuit for subtracting at least a part of the accelerometer output signal from the audio signal, and an output for outputting a result of the comparison circuit.

### TECHNICAL FIELD OF THE INVENTION

The present invention relates generally to electronic devices, and more particularly to noise cancellation in electronic devices.

### DESCRIPTION OF THE RELATED ART

Mobile electronic devices such as mobile phones, portable radios, personal communicators, and the like, have become increasingly common.

A disadvantage associated with mobile devices is their susceptibility to handling noise. Mobile devices often incur handling noise during communication. Handling noise may occur, for example, as a result of the user shifting the position of the device from one ear to another, exchanging the device from one hand to another, accidentally bumping or dropping the device, etc. Detrimentally, the microphone included in the mobile device typically picks up the handling noise. This can cause discomfort to the user as the mobile device oftentimes reproduces the handling noise in the earpiece of the mobile device. In addition, the noise may cause the party at the other end of the communication to experience discomfort and/or difficulty in hearing or understanding the communication.

Noise cancellation technology has been developed over the years. According to one noise cancellation technique, it is known to cancel unwanted environmental noise using a microphone specifically provided for detecting the noise. For example, noise cancelling headsets are frequently used by airline passengers to remove cabin noise, etc. However, providing noise cancellation in a mobile device in such manner requires at least one additional microphone in order to detect the noise so that the noise may then be removed. This increases the number of components and cost of the mobile device, which is undesirable particularly in a price competitive market.

In view of the aforementioned shortcomings, there is a strong need in the art for noise cancellation in a mobile device that does not rely on the provision of an additional microphone(s) for detecting and removing unwanted noise, and particularly handling noise.

### SUMMARY

The present invention provides a noise cancellation circuit suitable for use in a mobile device, and which does not require the provision of a microphone for detecting unwanted noise.

A noise cancellation circuit for an electronic device, according to the present invention, includes a first input configured to receive an audio signal from a microphone included in the electronic device, and a second input configured to receive an accelerometer output signal from an accelerometer included in the electronic device. In addition, the noise cancellation circuit includes a comparison circuit for subtracting at least a part of the accelerometer output signal from the audio signal, and an output for outputting a result of the comparison circuit.

According to one aspect, the noise cancellation circuit further includes a correlation circuit for correlating the accelerometer output signal and the audio signal, and the comparison circuit is operative on the correlated signals.

According to another aspect, the correlation circuit includes at least one of a phase adjustment circuit and a gain adjustment circuit for adjusting at least one of the accelerometer output signal and the audio signal relative to the other.

In accordance with another aspect, an electronic device is provided that includes the aforementioned noise cancellation circuit together with the microphone, the accelerometer, and audio circuitry configured to utilize the output of the noise cancellation circuit for operation of the electronic device.

According to still another aspect, the electronic device is a mobile phone.

According to yet another aspect, the accelerometer output signal is indicative of handling noise associated with handing of the electronic device, and the audio signal from the microphone is indicative of speech occurring as a result of a user operation of the electronic device and the handling noise during the user operation.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

FIG. 1 is a perspective view of a mobile device incorporating noise cancellation circuitry in accordance with an exemplary embodiment of the invention;

FIG. 2 is a block diagram of the mobile device in accordance with the exemplary embodiment of the invention; and

FIG. 3 is a block diagram of noise cancellation circuitry in accordance with an exemplary embodiment of the invention.

### DETAILED DESCRIPTION OF EMBODIMENTS

The present invention will now be described with reference to the figures, wherein like reference numerals are used to refer to like elements throughout.

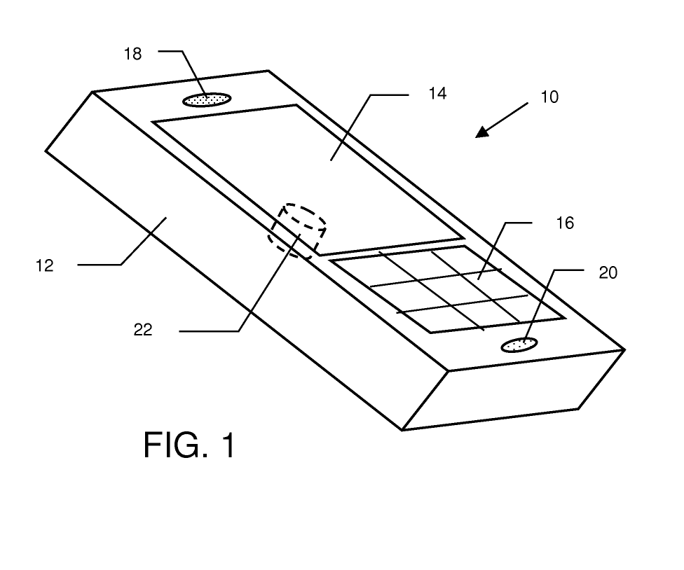

Referring initially to FIG. 1, a mobile device 10 is shown in accordance with an exemplary embodiment of the present invention. The device 10 as described herein is a mobile phone. However, those having ordinary skill in the art will appreciate that the mobile device 10 may be any other type of mobile communication device such as a portable radio or communicator (e.g., walkie-talkie), wireless telephone handset, etc.

The mobile phone 10 includes a body 12 which houses the circuitry described herein. In the exemplary embodiment, the body 12 has a “brick” design. It will be appreciated, however, that the body 12 may have any other type of housing without departing from the scope of the invention. For example, the body 12 may have a conventional clamshell or slider configuration.

The mobile phone 10 further includes a display 14 and keypad 16 which serve as a user interface as is known. The user may control various operations of the phone 10 (e.g., place or receive a call), input or access various data stored in the phone 10, surf the internet, etc., as is conventional. In addition, the mobile phone 10 includes a speaker 18 and microphone 20 that enable the user to converse with the party at the other end of a call.

Continuing to refer to FIG. 1, the mobile phone 10 further includes one or more accelerometers 22 (represented in phantom). In the exemplary embodiment, the accelerometer 22 is a single three-axis accelerometer. However, it will be appreciated that in another embodiment the accelerometer 22 may be made up of one or more single or multiple-axis accelerometers. Recently, accelerometers have been added to mobile phones as a means for detecting movement of the phone, the direction of movement, speed of movement, etc. As a result of the accelerometer 22 detecting such movement, the user may control operations of the phone, input commands, etc. For example, the user can “write” the number “three” in the air. The mobile phone can read this movement and then dial “3.” As another example, the accelerometer 22 may detect shaking of the phone 10. The phone 10 can be designed to respond to such an input by concluding a call or deleting spam messages, for example.

The mobile phone 10 of the present invention differs from such known devices in that the mobile phone 10 also utilizes the accelerometer 22 to perform noise cancellation. More specifically, the mobile phone 10 will experience handling noise as a result of being shifted from one ear to another, accidentally being bumped while being moved, being placed onto a table (e.g., temporarily or in order to engage in conference call, etc.). The particular cause of the handling noise is not germane to the invention at hand. However, it will be appreciated that the handling noise will coincide with movement of the mobile phone 10.

As with conventional mobile phones, the microphone 20 included in a mobile phone 10 will pick up a voice or other audio signal intended by the user to be communicated to a party at the receiving end of a call. When handling noise is created due to the phone 10 being moved abruptly or jostled, for example, the microphone 20 also tends to pick up such handling noise. The mobile phone 10 then communicates the handling noise in addition to the voice or other audio signal to the party at the receiving end of the call. This of course can result in discomfort and/or a reduction in intelligibility at the receiving end. Further, typically any audio signal produced by the microphone 20 is fed back to the user via the speaker 18 as a means by which the user can monitor the audio at his or her end. Thus, the handling noise picked up by the microphone 20 is also transmitted back to the user and results in discomfort, unintelligibility, etc.

Since handling noise is associated with the abrupt movement of the mobile phone 10, the accelerometer 22 included in the mobile phone will produce an output signal which is directly related to the handling noise. For example, if the mobile phone 10 is abruptly bumped during a call, such abrupt bumping will result in handling noise that is picked up by the microphone 20. In addition, the accelerometer 22 will detect a change in position/velocity/acceleration that directly coincides with the abrupt bump that caused the handling noise. As will be explained in more detail below, the mobile phone 10 recognizes the output of the accelerometer 22 as being representative of the handling noise created by the bump. The mobile phone 10 then extracts the handling noise thus detected by the accelerometer from the signal picked up by the microphone 20 in order to cancel the handling noise detected by the microphone 20 and result in the intended voice or other audio signal being communicated absent the noise.

Advantageously, the present invention does not require an additional microphone included within the mobile phone 10 in order to detect noise. The output of the accelerometer 22 sufficiently mirrors handling noise making it possible to perform noise reduction without an additional microphone.

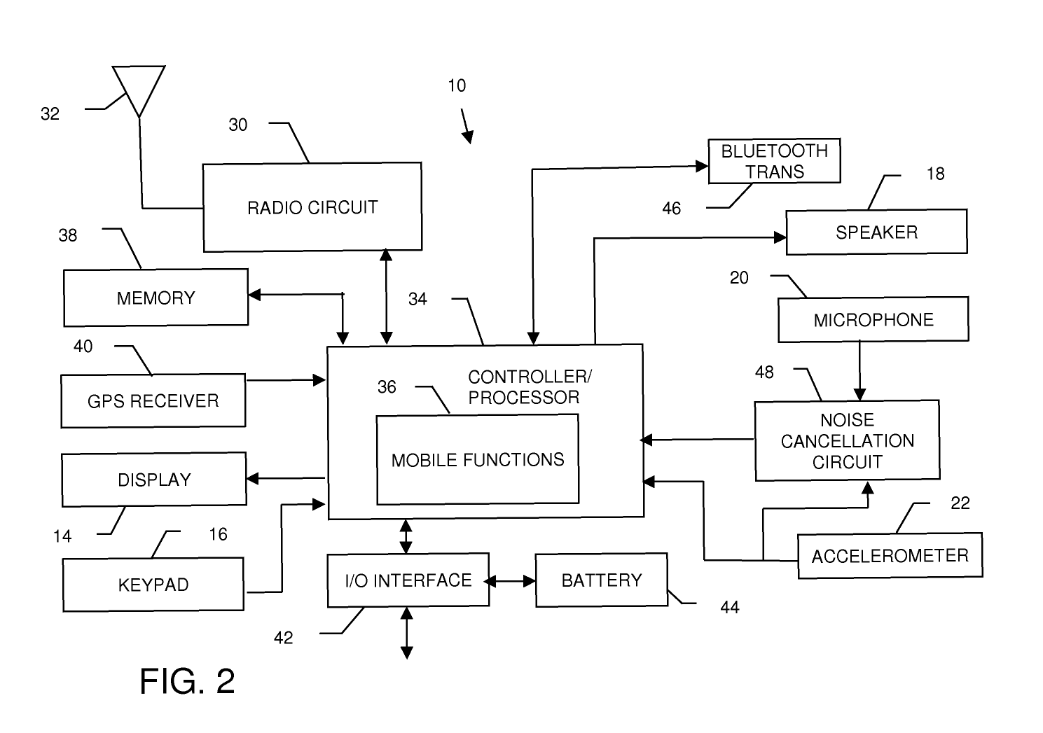

Referring now to FIG. 2, the mobile phone 10 includes a radio circuit 30 coupled to an antenna 32 for transmitting and receiving wireless communications. Such communications may be via a cellular service provider, satellite system, home network, etc. The particular type of wireless communication is not germane to the invention. Moreover, the invention is not limited to wireless devices as will be appreciated, and may encompass any other type of communication device (e.g., wired, etc.). The radio circuit 30 is coupled to a controller/processor 34 that provides control and processing for the various functions 36 of the mobile phone 10 as is conventional. The mobile phone 10 further includes a memory 38 suitable for storing programs, data, etc., enabling the phone to carry out its intended functions.

A GPS receiver 40 provides location information. An input/output interface 42 enables the mobile phone 10 to be connected to an external device such as a battery charger, laptop computer, etc. A battery 44 provides operational power to the phone 10. A Bluetooth transceiver 46 provides Bluetooth connectivity between the mobile phone 10 and another device such as a hands-free headset or the like.

In accordance with the present invention, the mobile phone 10 includes a noise cancellation circuit 48. The noise cancellation circuit 48 receives the signal output from the microphone 20. As discussed above, the output signal of the microphone 20 includes the voice or other audio signal together with any handling noise experienced by the mobile phone 10. The noise cancellation circuit 48 also receives the output of the accelerometer 22 which, as described above, is representative of the handling noise experienced by the mobile phone 10. The noise cancellation circuit 48 compares the output of the microphone 20 with the output of the accelerometer 22 so as to subtract the noise component from the microphone 20 output signal. The noise cancellation circuit 48 in turn outputs the noise-reduced audio signal to an audio portion (not shown) of the controller/processor 34 for subsequent processing, etc. The speaker 18, also connected to the audio portion of the controller/processor 34, serves to reproduce the audio experiencing noise cancellation to the user.

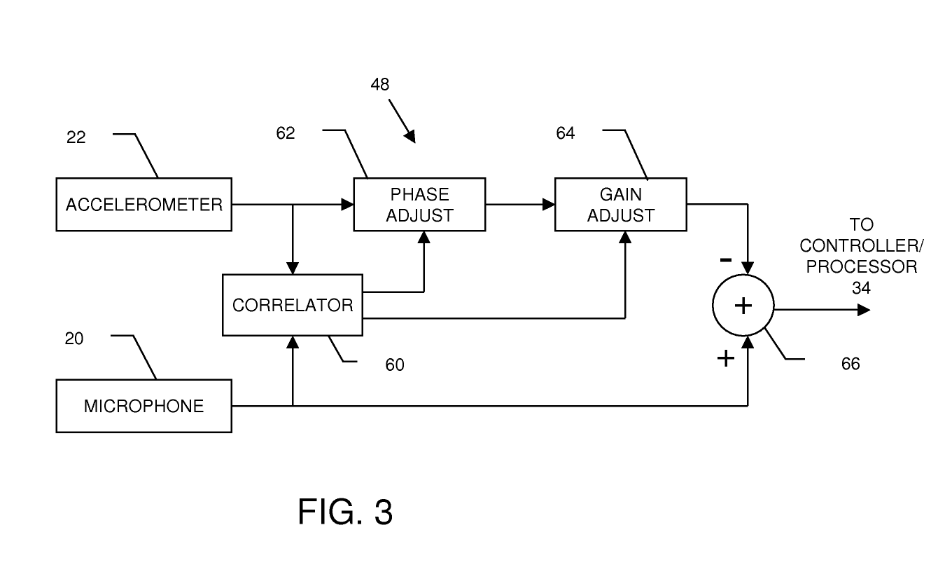

Referring now to FIG. 3, an exemplary embodiment of the noise cancellation circuit 48 is shown. According to the exemplary embodiment, the noise cancellation circuit 48 includes a correlator 60 that receives the output signals from the microphone 20 and the accelerometer 22. In addition, the noise cancellation circuit 48 includes a phase adjust circuit 62 and gain adjust circuit 64. Because the microphone 20 and accelerometer 22 will both tend to pick up handling noise as described above, the handling noise in both signals will tend to correlate. The voice or other audio signal otherwise picked up by the microphone 20 will not tend to correlate.

The correlator 60 correlates the handling noise in the outputs of the microphone 20 and the accelerometer 22. The handling noise in the respective outputs may be different in phase and/or amplitude. Accordingly, the correlator 60 adjusts the phase and/or amplitude of the output of the accelerometer 22 relative to the output of the microphone 20 by controlling a phase adjust circuit 62 and gain adjust circuit 64, respectively. Of course, it will be appreciated that in another embodiment the correlator 60 can instead adjust the phase and/or gain of the output signal of the microphone 20 relative to the output of the accelerometer 22. Furthermore, to the extent the microphone 20 and accelerometer 22 are configured so as to exhibit inherently good correlation in phase and/or amplitude, the phase adjust circuit 62 and/or gain adjust circuit 64 may be omitted as will be appreciated.

The correlated output signals from the microphone 20 and the accelerometer 22 are input to positive and negative inputs, respectively, of a summing junction 66. The summing junction 66 thereby compares the output of the microphone 20 with that of the accelerometer 22 by subtracting the handling noise from the output of the microphone 20 based on the output of the accelerometer 22. Consequently, the output of the summing junction 66 represents the output of the noise cancellation circuit 48. The output of the noise cancellation circuit thus represents the audio signal output from the microphone 20 absent the handling noise.

For sake of simplicity, the noise cancellation circuit 48 has been described herein primarily in the context of analog signals and circuitry. It will be appreciated, however, that all or part of the audio processing described herein may be performed digitally without departing from the scope of the invention.

Any of a variety of known signal separation techniques can be used to extract the handling noise from the output of the microphone 20 based on the output of the accelerometer 22, as will be appreciated based on the disclosure herein. FIG. 3 merely represents an exemplary embodiment in simplified form. For example, “blind source separation” is commonly used to separate two signals. The technique relies upon the assumption that the output signals of the microphone 20 and accelerometer 22 are de-correlated to some extent (i.e., statistically independent). Also, the regularity (auto-correlation) of each signal is preferably static, but could also be dynamic, like the typical behavior of human speech. It will be appreciated that there are then several ways (e.g., by means of signal processing) for performing the actual separation of handling noise from the output of the microphone 20 based on the output of the accelerometer 22.

It is noted that some accelerometers may not have the bandwidth of the microphone signal, and thus optimal (full bandwidth) correlation and cancellation may not be possible. In such a case, when detecting a large accelerometer amplitude and signal correlation within the accelerometer bandwidth, an uplink signal attenuation can be applied to make sure major handling noise (e.g. big ‘bumps’) is not transferred to the far end side. On the other hand, those accelerometers developed more recently are not limited in bandwidth to the audible range, thus enabling full bandwidth correlation and cancellation.

The present invention thereby provides noise cancellation in a mobile device that does not rely on the provision of an additional microphone(s) for detecting and removing unwanted noise, and particularly handling noise.

The term “electronic equipment” or “electronic device” as referred to herein includes portable radio communication equipment. The term “portable radio communication equipment”, also referred to herein as a “mobile radio terminal”, includes all equipment such as mobile phones, pagers, communicators, e.g., electronic organizers, personal digital assistants (PDAs), smartphones or the like.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A noise cancellation circuit for an electronic device, comprising:
a first input configured to receive an audio signal from a microphone included in the electronic device;
a second input configured to receive an accelerometer output signal from an accelerometer included in the electronic device;
a comparison circuit for subtracting at least a part of the accelerometer output signal from the audio signal; and
an output for outputting a result of the comparison circuit.

2. The noise cancellation circuit of claim 1, further comprising a correlation circuit for correlating the accelerometer output signal and the audio signal, and wherein the comparison circuit is operative on the correlated signals.

3. The noise cancellation circuit of claim 2, wherein the correlation circuit comprises at least one of a phase adjustment circuit and a gain adjustment circuit for adjusting at least one of the accelerometer output signal and the audio signal relative to the other.

4. An electronic device, comprising:
the noise cancellation circuit of claim 1;
the microphone;
the accelerometer; and
audio circuitry configured to utilize the output of the noise cancellation circuit for operation of the electronic device.

5. The electronic device of claim 4, wherein the electronic device is a mobile phone.

6. The electronic device of claim 5, wherein the accelerometer output signal is indicative of handling noise associated with handing of the electronic device, and the audio signal from the microphone is indicative of speech occurring as a result of a user operation of the electronic device and the handling noise during the user operation.
